(19) United States
(12) Patent Application Publication
(10) Pub. No.: US 2017/0300804 A1
(43) Pub. Date: Oct. 19, 2017

(54) SOFTWARE ARCHITECTURE FOR EXPERT SYSTEM

(71) Applicant: COMMISSARIAT A L'ENERGIE ATOMIQUE ET AUX ENERGIES ALTERNATIVES, PARIS (FR)

(72) Inventor: Jean-Philippe POLI, PARIS (FR)

(21) Appl. No.: 15/516,859

(22) PCT Filed: Sep. 30, 2015
(86) PCT No.: PCT/EP2015/072603

§ 371 Date: Apr. 4, 2017

(30) Foreign Application Priority Data
Oct. 29, 2014 (FR) 1460382

(51) Int. Cl. G06N 3/00

(52) U.S. Cl. CPC G06N 3/006

(57) ABSTRACT

A method implemented on a computer comprises the steps of receiving an input value to be evaluated; queuing the input value in a queue; selecting, in the queue, a queued input value; determining an output value by evaluating, by inference of the rules base, the queued input value selected. Developments describe the broadcasting of one or more output values, the scheduling in time and/or in space of the evaluations of the queued input values (notably in terms of computation resources), the selective evaluation of input values, the use of a dependency graph, parameters of expiration of parts of rules in time, the use of inference according to fuzzy logic. System aspects, notably component and software aspects, are described.

### FIELD OF THE INVENTION

The invention relates to the field of artificial intelligence in general and the field of rules-based expert systems in particular, notably based on fuzzy logic.

### STATE OF THE ART

The fuzzy intelligent systems (FIS)—or fuzzy expert systems—are systems which integrate or implement human expertise and which aim to automate or mimic the reasoning of human experts faced with complex systems. These eminently technical systems can be based on different aspects of mathematical logic and in particular on the logic called “fuzzy logic”.

The so-called “fuzzy” expert systems generally require more computations than the standard or conventional expert systems. Moreover, these systems generally require these significant computations to be reiterated in time (for example when they are applied to dynamic systems which change over time).

The so-called “fuzzy” expert systems generally require computation power. The scientists developing fuzzy expert systems are generally required to construct increasingly complex and “rich” operators. The computation time can then become greater than the conjunctions, disjunctions and negations that are generally found with the conventional expert systems.

Moreover, the fuzzy expert systems require the repetition of these computations. In effect, in the conventional expert systems, only certain rules are activated at a given moment whereas, with the fuzzy expert systems, all the rules have to be recomputed (at the very least a great proportion of them). According to the prior art of the expert systems currently marketed (e.g. offered for downloading or for purchase), the only means currently available for generating an input data stream (that is to say multiple data received over time) consists in relaunching the evaluation at each time step. This approach in particular necessitates reevaluating the rules implemented in such a fuzzy expert system and repeatedly in time (for example every second). This approach produces the effect of a continuous decision-making (e.g. “with the stream” or “progressively” or “as fast as” or “continuously”, even in some cases an “interactive” or even “real-time” or “quasi-real-time” or “critical flow” decision). One technical problem which arises is that all the rules have to be reevaluated on each iteration, including those whose inputs have not changed. That is all the more costly in computation terms as operators whose evaluation can be very complex can be involved in these computations. This under-optimized situation is intrinsically unsatisfactory. In practice also, the devices and appliances involved may not have sufficient computation power, even though the computation might be distributed between several appliances cooperating with one another. In a particular context of use, that of the internet of things, a very large number of interacting things are generally provided but these things do not necessarily have appropriate computation means.

In order to resolve these various aspects, the patent literature remains dumb when it comes to fuzzy logic. There are rare patent documents that deal with the initial technical problem but in the context of conventional expert systems, that is to say without taking into account the specifics relating to fuzzy logic. In the conventional context, the document U.S. Pat. No. 8,214,316 teaches that the evaluation of the rules (e.g. “forward chaining”) can be subjected to a notification of the inputs that have changed. The other known documents do not deal with fuzzy logic.

The invention proposed in the present document makes it possible to address these needs or limitations, at least partly.

### SUMMARY OF THE INVENTION

A method is disclosed that is implemented on a computer comprising the steps consisting in receiving an input value to be evaluated; queuing the input value in a queue; selecting, in the queue, a queued input value; determining an output value by evaluating, by inference by means of the rules base, the queued input value selected. Developments describe the broadcasting of one or more output values, the scheduling in time and/or in space of the evaluations of the queued input values (notably in terms of computation resources), the selective evaluation of input values, the use of a dependency graph, parameters of expiration of parts of rules in time, the use of inference according to fuzzy logic. System aspects, notably component and software aspects, are described.

According to a general aspect of the invention, a software architecture is disclosed that makes it possible to obtain optimized performance levels, aiming to identify the different output data as a function of the rules and of the input data.

More specifically, according to one embodiment of the invention, a fuzzy expert system is disclosed that is capable of managing a stream (continuous or regular or discontinuous or irregular or periodic or aperiodic or intermittent) of inputs and of progressively returning (e.g. “with the stream”) the values of the corresponding outputs.

The different embodiments of the invention are advantageously used in technical fields such as home automation or industrial regulation. Generally, the invention will be applicable for monitoring a system or a given object by means of several sensors which measure different phenomena continuously (or at possibly different frequencies, intermittently or periodically). Methods and systems according to the invention can make it possible to implement a home-automation regulation system. For example, a fuzzy expert system according to the invention can measure over time (discretely or continuously) the variations of temperatures, of brightness and of occupancy of the rooms to deduce and/or actuate corresponding commands (for example opening shutters).

Advantageously, but optionally, the writing of the rules according to the invention is done in plain language (rather than by means of mathematical operators). That makes it possible to conceal—at least partly—from the operator who inputs his or her expert rules, the mathematical complexity underlying the model currently running. The use of plain language also makes it possible to improve the expressiveness of the expert system. This feature makes it possible to obtain a better coverage of real situations by the rules. In other words, a fuzzy expert system based on rules expressed in plain language ultimately allows for a better “capture” of reality. In other words, certain embodiments advantageously manipulate rules or expressions using the vocabulary of plain language, improving the comprehension (and therefore the subsequent manipulation) of said rules or expressions.

This advantage is inherent to fuzzy logic, as indicated in “The concept of a linguistic variable and its applications” by L. A. Zadeh.

The invention is advantageously applicable for both “conventional” and “fuzzy” expert systems.

Fuzzy logic is an extension of conventional logic with approximate reasoning. Through its numeric aspects, it opposes the modal logics. Unlike Boolean algebra, fuzzy logic allows the truth value of a condition to cover a domain other than the {true, false} pair. In fuzzy logic, there are degrees in the satisfaction of a condition. Fuzzy logic attributes degrees of truth to a relationship of the style x is_more_close_to y than_to z, constructed and/or refined by learning. Generally, the fuzzy relationships will make it possible to code graduated, empirical or typical knowledges, acquired directly or by heuristics, inductions, etc. The transitions used can be of linear, hyperbolic (e.g. hyperbolic sigmoid or tangent), exponential, Gaussian, and other such types.

The methods and systems according to the invention generally facilitate the human-machine interactions. In particular, they can make it possible to relieve the user of tedious, sometimes repetitive and often complex, procedures. Generally, the different embodiments of the invention lead to the optimization of the cognitive effort to be provided by the user when using the expert system according to the invention. In other words, the technical effects linked to certain aspects of the invention correspond to a reduction of the cognitive load of the user.

### DESCRIPTION OF THE FIGURES

Different aspects and advantages of the invention will emerge in support of the description of a preferred, but nonlimiting, mode of implementation of the invention, with reference to the figures below:

FIG. 1 schematically represents the general architecture of an example of method according to the invention;

FIG. 2 illustrates an example of rule represented in graph form;

FIG. 3 illustrates an example of graph with nodes exhibiting priorities.

### DETAILED DESCRIPTION OF THE INVENTION

Generally, a rules-based system is a tool capable of reproducing the cognitive mechanisms of an expert, in a particular field. More specifically, an expert system is software capable of answering questions, by performing a reasoning based on known facts and rules. It can be used in particular as a decision aid tool. An expert system breaks down into three parts: a facts base, a rules base and an inference engine. The inference engine is capable of using facts and rules to produce new facts, until it arrives at the response to the expert question posed. An expert system can rely on formal logic mechanisms and use deductive reasoning. It can for example rely on the logic of propositions (“0 order logic”), or else the logic of first order predicates (“1^{st}-order logic”). Fuzzy logic techniques can also be used.

The algorithms for performing the computation by inference are various and can in particular be specific to the nature of the logic which is implemented. For example, for the 0 order logic—used among other things, by the business rule management systems (BRMS)—forward or backward chaining algorithms make it possible to start from the facts and deduce conclusions therefrom (or, vice versa, to start from conclusions to know the facts which are at the origin thereof). In the 1980s, the Rete and Novel algorithms replaced these chaining algorithms by proposing a step of filtering of rules impacted by the facts. For the 1^{st}-order logic, the chaining algorithms are used jointly with a unification algorithm which makes it possible to instantiate a predicate for one or more individuals in the space considered. Finally, in fuzzy logic, the Zadeh, Mamdani and Sugeno inference methods can be used.

In the knowledge based systems expressed in plain language, a knowledge is generally represented by rules of the form: “if a quantity is [adjective] and another quantity is [adjective] then the output quantity is [adjective]”. For example: “if the outside temperature is very cold and the rain is fine, then the risk of ice is great”.

The methods and systems according to the invention perform one or more operations or steps, including steps of a) storage, b) measurement or observation, c) scheduling of the evaluation, d) actual evaluation and e) broadcast.

More specifically, the method comprises one or more steps out of

a) storage steps; the modifications observed regarding the inputs can be stored in a queue (this queue or “buffer” advantageously makes it possible to manipulate input data which could change or accumulate more quickly than the processing capacities of the system allow). Possibly, by application of its own policy, the queue according to the invention can delete, and/or merge, elements (for example if the refresh frequency of the inputs is too high). In other words, the queue may not be “passive” (in the sense of a simple temporary storage space) but, on the contrary, be “active”, i.e. actively participate in the overall system;

b) steps of measurement or of observation or of monitoring or of tracking of the current context (comprising, and not limited to, monitoring the state of the machine, i.e. processor or computation means load or activity, instantaneous use of the memory, etc.); in addition, these steps can also comprise steps of selection of certain elements to be removed from the queue, for example in order for them to be processed (according to the policy implemented);

c) scheduling steps regarding the evaluation of the elements selected on the different physical computation means (according to the different levels of granularity accessible, from the clusters of servers, the servers, the processors in the servers, the cores within the processors; also the subdivision of the computation tasks, for example the computation threads, etc.). For example, if the elements are independent (that is to say they do not influence the same outputs), it is possible in some cases to proceed with parallel computations. In other words, the scheduling component can select one or more inputs (or a group of inputs) having changed or having been modified and can decide to assign its evaluation to an entity (a core, a computer) and/or may simply not take into account a group of inputs if it judges that the machine is too busy and/or that these modifications are not informative or redundant.

d) steps of evaluation of the outputs based on the elements selected upstream;

e) steps of broadcasting of the new output values (given the locally defined broadcasting policy); the modalities of said broadcasting can be performed in various ways and intended either for various sub entities (generally to outside the fuzzy expert system, but in particular cases to components internal to this system).

Generally, a method is disclosed that is implemented on a management computer of a rules base 150, the method comprising the steps consisting in receiving an input value 101 to be evaluated; evaluating, by inference by means of the rules base 150, an output value 102 corresponding to the input value 101; characterized in that the method comprises the steps consisting in queuing the input value in a queue 110; selecting 112, within the queue 110, a queued input value; and determining an output value 102 by evaluating, by inference by means of the rules base 150, the selected queued input value.

An input value can be a numerical value (for example “38”) or a symbolic datum or else a variable (for example “α”) or even a character string (for example “38° C ”).

The rules base 150 comprises rules.

A rule—in the sense of the invention—consists of several elements: propositions, expressions (unary, binary, etc.) and conclusions. The propositions can comprise linguistic variables in the context of fuzzy logic. A rule comprises several expressions (premises, conclusions) and one or more operators (for example standard predefined logic operators “if”, “then”, etc., as well as specific operators “before”, “after”, “as long as”). For example, a rule can be “if the temperature is high then open the window”). An expression can notably comprise a character string (for example “if the temperature is high” or “open the window”). An expression can be a regular expression. An expression can be a rational expression. An expression can be a formal expression.

Advantageously, a rule or an expression manipulated by the method according to the invention comprises vocabulary belonging to the plain language (i.e. the words or character strings are words of the plain language), improving the understanding of the rules by the user and reinforcing the expressiveness of these same rules (e.g. their capacity to “capture” the real world).

An input value according to the invention is “queued” or “placed in a queue”.

An input value is then selected from among the queued values.

Specifically, this selection can be on account of the queue itself (for example when the storage capacity of the queue is reached, the latter can “push” one or more input values to the evaluation or to other components of the system).

Generally, the selection is on account of the scheduling module (i.e. steps consisting in scheduling the evaluations), for example according to a “pull” mode. The scheduling component (the scheduling steps) participates in the control of the system thus defined.

In some embodiments, the queuing can be of the “First In First Out” type. In some embodiments, the queuing can involving processing operations on the values. The queue can in effect be associated with a “policy”, that is to say a set of rules. These rules are predefined. They can be of logic type (according to various modalities, for example conventional logic. They are sometimes configurable (previously and/or on demand i.e. during execution of the overall method or system). In the case in point, when it comes queues, the queued values can be “ordered” and/or “sorted” and/or “grouped together” and/or “erased”. The processing criteria are variable (weightings, correlation, scoring, etc.).

The queuing step (i.e. the input queuing component) can place the perceived modifications of the inputs in a queue so as to lose no information. In one embodiment, the queue (or the corresponding system component) is in effect not necessarily of limited capacity like a buffer can be; a queue according to the invention can possibly be adapted to the management of a large quantity of data. Depending on its policy, the input queuing component can eliminate elements or merge them, for example if an input changes values without the change being meaningful. In another example, it also makes it possible to group them together by time of arrival.

Actively invoked by the scheduling step or pushed by the management of the queue, an input value is selected.

Subsequently, the input value is “executed” (i.e. “the expression or the rule is evaluated”). In other words, according to a systematic view, the evaluation component receives a group of modified inputs and by inference relative to the rules base computes the outputs.

For example, the value of the speed input (“is the speed high?”) can be evaluated: a value can be determined as output. Considering the fuzzy rule or command “if the fever is high, then administer aspirin”, an input will be a temperature value (for example “41° C”). It can be considered that a fever is not high below 38° C., and that it is high above 40° C. according to the rules base (i.e. gradually increasingly high between 38° C. and 40° C. (linearly, exponentially, or according to continuous functions). An output value will be an expression “administer aspirin” or a value/quantification, for example “X” milligrams of aspirin.

The actual evaluation is performed by inference. Inference is a movement of thought which goes from principles to conclusion. The term denotes the actions of inter relating of a set of propositions, culminating in a demonstration of truth, or falseness or of probability, in the form of a proposition called conclusion. According to the invention, the inference can be deductive or inductive or even abductive.

In one development, the method further comprises a step consisting in broadcasting one or more output values 102.

In system terms, the scheduling component, in application of its policy, can select a particular output value.

The broadcasting component can, also according to its policy, over-select values before communicating them (i.e. select values previously selected).

For example, the broadcasting component can communicate or broadcast output values at regular intervals in time and/or when a particular event occurs and/or if certain conditions are met, etc. The inclusion of the history can, for example, contribute to the merging or to the assimilation of the input values; the inclusion of certain predefined thresholds can lead the broadcasting component to not reiterate the broadcasting of a result associated with an input if a very close value (e.g. within predefined threshold limits) has already been communicated in the past, at the very least during a time window that is also predefined, etc.

In other words, the broadcasting step (respectively the broadcasting component) comprises a step consisting in communicating the values of the outputs to the outside of the fuzzy expert system according to its policy. It can thus broadcast the values of just the outputs that have changed values and/or attach interpretation information thereto (all or some of the values making it possible to trace back the inference for example) and/or communicate the values of the outputs that have undergone a significant change (above a threshold) and/or the output values which have not changed value but for which the interpretation information is different.

The component or unit or member responsible for the actual “broadcasting” or “communication” or “publication” of this output value 102 can be the component 130 for example. “Broadcasting” or “communication” or “publication” means an outside or external broadcasting or communication (the other exchanges or passages of messages are performed internally to the system 100. The system 100 from the point of view of the user or from a systemic point of view appears as a “black box”, which processes (according to a regulation or specific internal processing operations) a certain number of data and publishes certain values as output. There are many communication modalities: visual display (LCD screen, light flash, etc.), transmission of data or passing of messages (e.g. email, data channel, RSS stream), audio signal or emission, vibrant signal (or according to a combination of these communication modalities).

In one development, the step consisting in evaluating a selected queued input value comprises a step consisting in scheduling in time and/or in space the evaluations of the queued input values.

It is stressed that at least one queued input value selected upstream can be evaluated. The evaluation step can in effect comprise steps consisting in allocating the computation tasks to the different computation means (physical and also temporal allocation). The term “schedule” means “organize” (i.e. sequencing in time and in space). The scheduling in time and/or in space consists in particular and for example in ordering or organizing or orchestrating the computations (for example the “threads” or according to any other computation sub task corresponding to different levels of granularity) and in assigning them to computation units, that is to say an allocation of the computation tasks in space (physically between the different processors or processor cores, multicore or manycore CPU).

In one development, a selection of input values (having been selected) is evaluated in turn.

The evaluation or execution can be selective.

Of the input values selected in the queue, for example by the scheduling component, only a fraction may possibly be ultimately evaluated. In other words, a selection of previously selected input values may be evaluated.

The method according to the invention in effect makes it possible to not compute or evaluate certain input values. Positively, only certain expressions or input values are evaluated.

This selection can be made because of different constraints or reasons (e.g. saving on computations, speed, etc.). According to one aspect of the invention, the method is economical in computations.

The manner in which the expressions or values which will be the only ones evaluated are selected can be conducted in different ways (e.g. relevance criteria, thresholds, etc.).

The method may evaluate one or more input values only when necessary.

In one embodiment, the queuing step or unit can group together inputs, for example according to the context of modification (for example, the time at which the inputs changed) and the scheduling step or the scheduler can retrieve a group of inputs associated with this same context. In a variant, the context may be the place where the inputs changed. Other variants use combinations of date and of place etc.

In one development, the method further comprises a step consisting in separating the graph corresponding to the rules base 150 into several separate sub-graphs, a step consisting in selecting at least one sub-graph comprising a node corresponding to a selected queued input value and a step consisting in evaluating said selected sub-graph.

In order to determine which input values need to be evaluated, it is advantageous to represent the dependency between all the elements which make up the rule or the expression. This way, optimizations can be conducted (eliminations of redundancies, computations restricted to only the necessary computations, etc.).

Two methods are described hereinbelow.

In a particular embodiment, a representation of the rules in graph form makes it possible to isolate the nodes (corresponding to the different rules or expressions that make up these rules) for which the reevaluation is advantageous.

The rules base can be represented in the form of a graph rather than in the form of a forest (a set of trees) because, by so doing, it is possible to ensure the uniqueness of the nodes. According to this aspect, a part of rule (a proposition, an expression, a conclusion, an input, an output, etc.) can be represented only by a single node. In other words, there is a bijection from the nodes to the parts of rules and the rules themselves. Thus, if a same part of rule appears several times in different rules, it can be evaluated just once.

When a certain subset of the inputs changes at a time t, only the nodes which are affected can in fact be re-evaluated.

It is advantageous to identify different separate sub-graphs of the graph (which represents all the rules base). In physical terms, the graph G corresponding to the base of all the rules will be separated into several connecting graphs Gi for which there is no common edge between these different Gi. The separate graphs thus have no node in common, therefore no part in common, therefore no input or output in common. Thus, it becomes possible to evaluate the different separate sub-graphs of the global graph in parallel.

The graph is oriented (for example, the node A oriented toward the node B). The evaluation of a given node can have a consequence on the evaluation of a node which depends on it. To proceed with the evaluation of the nodes of the graph, said graph can be browsed. On the loading of the rules base, during the construction of the graph, each node is associated with a certain evaluation “priority” related to its depth in the graph (in one embodiment, the input values can be associated with a priority equal to zero; other nodes can have a same priority but generally, the different nodes are associated with different priorities). Once the different priorities (or depths) are determined, some nodes—determined by the paths linking them to the nodes representing an input of the system —are recomputed. The nodes are evaluated in turn only if at least one of their predecessors has changed value. If a node does not change value, the evaluation of the paths starting from it is not performed.

The global graph associated with or representing the rules base is first of all separated into several separate sub-graphs, which allows for parallel processing operations or analyses (the sub-graphs are “independent”). The method then selects one or more sub-graphs. A selection criterion comprises the fact of detecting one or more nodes representing, for example, the only input values that have changed sufficiently, i.e. which have been selected by the scheduler from the queue containing the input values. Finally, the sub-graph is evaluated.

Separating the graph into several sub-graphs subsequently makes it possible to parallelize the computations and allocate these computations to independent cores and/or threads. Advantageously, this parallelization lessens the possibilities of errors in the computations, improves the processing speed, optimizes the use of the computation resources or means, etc.

In one development, the step consisting in evaluating a sub-graph comprises a step consisting in browsing said sub-graph, a step consisting in recursively associating a priority with each node of the sub-graph and a step consisting in evaluating the nodes by ascending priority.

The priority is, more generally, a coefficient or a parameter or a value. Other embodiments of the invention involve not a priority value but a “depth”. There are various ways of annotating the graph. It is possible, in one embodiment, to associate the inputs with a value equal to zero and to proceed by incrementation as the graph is browsed (the nodes associated with the lowest priority values then being processed first). Other embodiments of the invention can use other weighting or scoring techniques.

In one development, the method further comprises a step consisting in comparing the character strings that make up the expressions that make up the rules of the rules base, a step consisting in deleting the redundancies between said expressions so as to obtain unique expressions and a step consisting in evaluating said unique expressions.

As an alternative to the representation in graph form, i.e. without recourse to a mode of representation and/or of analysis of the data in graph form (i.e. representation only, analysis only, or representation and analysis in graph form), it is possible to proceed with comparisons of character strings.

One expression may be present in several rules. For example, the expression “the temperature is high” can be present in a first rule “if the temperature is high then open the window” and a second rule “if the temperature is high then administer aspirin”. It is possible to represent uniquely expressions appearing several times in the rules base. One way of proceeding comprises operations of comparison of character strings that make up the expressions or rules. The redundancies can be partially or totally eliminated.

In one development, a part of a rule of the rules base 150 is associated with a time expiration parameter/value.

In some embodiments, no rule (or a fortiori part of rule) expires, i.e. the validity of the rule is persistent in time. In other embodiments, one or more rules (or parts of rules) can expire in time (according to various parameterizations).

According to one aspect of the invention, a part or portion of rule can expire in time (“go out of date”, become “obsolete” or “lapse” or “non-actionable” or “without effect”). A part of rule can be a proposition or an expression for example. The expirable parts of rules are therefore objects which have a limited life span in time (or whose computed value has a limited duration in time). When this duration is exceeded, i.e. expired or out of date, the scheduler (among other units of the system) can take the decision to not evaluate the part of rule concerned. In practice, the scheduler can check whether the expired expression is used in one of the computations as scheduled in time and/or space. If appropriate, the expression is evaluated; by default, the expression is left unchanged with its expired value. In some cases, the expired expression is eliminated.

For example, if a rule takes the form “if it is fine tomorrow and it rains today then delay the washing”, the expression “it is fine tomorrow” can change value for two reasons: either the weather forecasts have changed (in this case, it is not truly an expiration but a simple change of value as a function of the system inputs) or the value changes (for example because of the transition from the day from Wednesday at midnight to Thursday). Even if the value of the weather forecast for Wednesday remains unchanged, the expression will expire (in this case, it expires every 24 hours).

Generally, each expression can expire according to different time parameters. In some embodiments, advanced time parameters are used (time intervals but also and for example according to time derivatives, i.e. acceleration of trends, etc.). Expressions or parts of rules can expire according to very wide-ranging time scales (e.g. every second or every millisecond for reactive systems).

The expiration of the validity of the parts of rules can be modulated in a more sophisticated manner for example according to various parameters, tests, circumstances or conditions. For example, space parameters can be taken into account to determine the expiration or the non-expiration of a rule (e.g. geolocation or “geofencing” conditions, etc.).

In one development, two substantially concomitant input values are assimilated into one and the same input.

In embodiments, it is possible to consider that the modifications of two different inputs occurring at intervals of a few milliseconds are in fact concomitant (“substantially” concomitant) and subsequently merge them or assimilate them. The optional use of predefined thresholds allows said assimilation.

In one development, at least one rule is expressed in plain language.

The advantage associated with the fact that a rule is expressed in plain language, unlike a formal language, lies in the expressiveness of the duly constituted rules base. Furthermore, in a context of editing of these rules, this form is advantageous because it is comprehensible to the user.

In one development, the evaluation by inference is performed according to 0-order logic or 1^{st}-order logic or according to fuzzy logic.

Various families of algorithms exist for the implementation of the evaluation by inference in the method according to the invention. One or other of the logics cited can be used according to the advantages associated with these different logics and with the contexts of use.

A computer program product is disclosed, said computer program comprising code instructions making it possible to perform one or more of the steps of the method, when said program is run on a computer.

A system is disclosed comprising means for implementing one or more of the steps of the method.

In one development, the system comprises means for receiving an input value 101 to be evaluated; means for evaluating, by inference by means of the rules base 150, an output value 102 corresponding to the input value 101; and is characterized in that the system comprises storage means for queuing the input value 101; computation means for selecting a queued input value and for scheduling in time and/or in space the evaluations of one or more queued input values; computation means for evaluating the queued selected queued input value as an output value 102; input/output means for broadcasting one or more output values 102.

The storage means designate, for example, volatile or persistent memories (e.g. flash memory, hard disk, DDRAM, SRAM, etc). The computation means are processors or processor cores. The input/output (or “I/O”) means are communication means of different types (radio, wireless, wired, e.g. Ethernet; using a variety of TCP/IP or other protocols).

In one development, the system comprises an input/output component for receiving one or more input values; a queuing component suitable for performing one or more of the steps out of those consisting in storing, grouping together, merging and deleting input values; a scheduling component suitable for performing one or more of the steps out of those consisting in selecting, deleting, grouping together, merging, allocating queued input values; an evaluation component suitable for evaluating one or more input values queued and manipulated by the scheduling component by inference by means of the rules base; a broadcasting component suitable for selecting and communicating one or more input values.

A policy associated with a component or with a unit corresponds to a set of rules “internal” to the component or to the unit. A policy can be static, i.e. predefined and constant over time. A policy can also be dynamic, i.e. variable over time. Talking about a system made up of a set of components each associated with such “policies” a “general” policy can be drawn, in the sense of an emergence or of an observation, resulting from the combination of the different policies implemented effectively locally for each component. In other words, the set of the policies of the different components can parameterize the global behavior of the global system. In particular, different configuration files for the policies implemented in the different components can be made available (e.g. defined by the user, the operator of the monitoring service, via the network, etc.).

The different policies are generally expressed by rules linking descriptive attributes of the problem or of the aspect of the system to be monitored (e.g. in terms of input refresh times, output refresh frequency, etc.) or descriptive attributes of the platform on which the system runs (e.g. number and occupancy of the processors, quantity of memory available and used, etc.) and thresholds. For example, for the queuing component, a rule can be that if an input changes value several times in less than a second, only the last value will be selected. For the scheduling component, if the platform has several cores available, the execution will be able to be parallelized. For the evaluation component, if a “BEFORE” operator is used for example, a “version” of the operator—specific to the problem or to the aspect of the system monitored—for example a variant of the implementation of the operator will be able to be implemented. For the broadcasting component, a policy will be able to consist in broadcasting the modifications every second for example.

In particular, concerning the time aspect, a component policy can consider that modifications relating to two different inputs occurring at intervals of a few milliseconds are in fact concomitant (“substantially” concomitant) and will therefore be assimilated in one and the same input. A policy can configure or predefine assimilations or mergings or aggregations of data. A data merging or aggregation or assimilation policy can advantageously be used when it is known that the values of the inputs are provided by a communication means with a certain latency (network, etc.).

A policy is therefore a means of configuring or of parameterizing a component in relation to a given application.

The scheduling component can “select” and “allocate” previously queued input values: in other words, it can “propagate” particular input values (it can in particular select these values through the knowledge of the dependency graph). The broadcasting component can perform the communication at a subsequent time and therefore “defer” the communication or the broadcast.

A component policy comprises a set of rules related to tangible execution means for executing these rules. The policy associated with a component makes it possible to parameterize and to modify the behavior (“emergent”) of the component to which it is applied.

A policy generally comprises a set of operations chosen from the operations consisting in filtering, ordering, sorting, segmenting, dividing, merging, deleting, disregarding, adding, substituting, concatenating, compressing, storing one or more input values.

A policy can be parameterized (e.g. previously) or parameterizable (e.g. according to variables for example). In other words, a policy can be configured or configurable.

In one embodiment, a policy can be “universal”, in as much as the different policies associated with the different components can be interchangeable. In another embodiment, the policies can specifically not be interchangeable between the different components. For example, regarding the operation consisting in filtering, the queuing unit will not apply the same type of filtering as the broadcasting unit or even the scheduler.

Some particular embodiments preferentially associate certain types of operations with certain components. In these particular embodiments, the queuing component is suitable for performing one or more of the steps out of those consisting in storing, grouping together, merging and eliminating input values or data; the scheduling component is suitable for performing one or more of the steps out of those consisting in deleting, canceling, jumping, merging, allocating (to computation resources for example), associating or annotating (e.g. through state values) input values; the broadcasting component is suitable for performing one or more of the steps out of those consisting in selecting (e.g. according to predefined criteria or thresholds), grouping together, deferring, choosing instants in time, canceling input values or data; the evaluation component is suitable for performing one or more of the steps out of those consisting in restricting or extending the operators that can be evaluated (by choosing predefined implementation variants for example, i.e. changing the semantics of the operators).

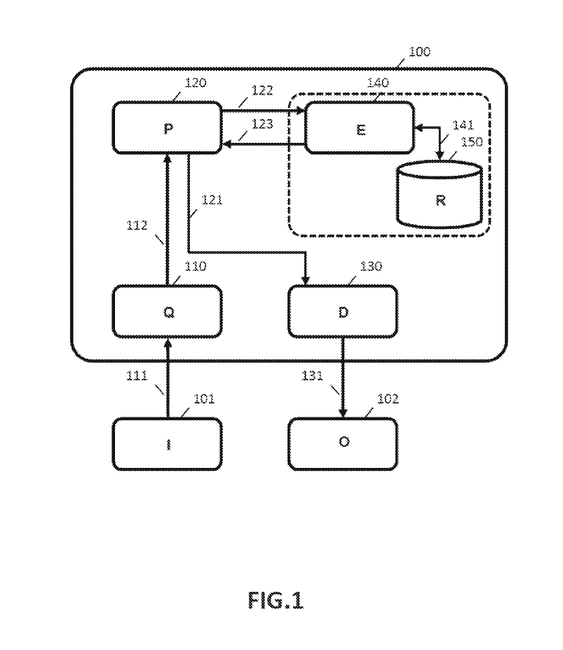

FIG. 1 schematically represents the general architecture of an example of a method according to the invention.

The architecture of a fuzzy expert system 100 is made up of a rules base 150, a set of inputs 101 (or “I”) and a set of outputs 102 (or “O”). When the inputs 101 change, the outputs 102 are computed according to the rules base 150. This architecture is that of a “conventional” fuzzy expert system.

According to the invention, three components specific to this architecture are added.

The component 110 is a queuing component (or “Q”) for the inputs 101. In the context of a system whose inputs change value over time, e.g. progressively or “with the stream”, this component makes it possible to capture these changes. In some embodiments, this component can apply different queuing policies. For example, certain filtering rules—or policies—can take account of the capacities of the machine (e.g. of the host machine or of the monitored machine) and/or of the very nature of the changes (for example if the value of an output has changed by less than 1%, it is not useful to consider its new value), or even group together the modifications (not exhaustive).

The component 130 is an output broadcasting component. The outputs 102 change over time. This component according to the invention advantageously makes it possible to “broadcast” (or “notify” or “communicate” or “transmit”) the new output values 102. In some embodiments, explanations on the changing of the values of the outputs can also be communicated. The component 130, like the component 110, can apply different predefined policies. For example, the component 110 can inform on changes of value of the outputs 102 with a predefined time interval (for example every N seconds) and/or inform as soon as an activation value has changed, according to thresholds or threshold bands (not exhaustive).

The component 120 is a computation scheduling component. This component 120 is informed or to notify in the step 112 of the arrival of one or more changes by the queuing unit component 110. The component 120 can then trigger or actuate or invoke or control the output broadcasting component 130. Depending on the current state of the machine or of the set of machines, the component 120 is capable of assigning the computations to a processor or to a core on a particular machine, of prioritizing a computation or a computation sub-task (e.g. thread), etc.

As FIG. 1 shows, at each instant t, the set of the inputs 101 having changed are queued by the queuing unit 110 (possibly processed according to its policy). During the evaluation 140, if new modifications of the input values 101 occur, the latter will not be lost but placed after the queue in the component 110. In the step 112, the queuing unit then notifies the scheduling unit 120 that new inputs are available. This scheduling unit 120 then applies its policy and invokes the evaluation unit 140 in the step 122. The evaluation unit 140, at the end of the computation, informs or notifies in return (step 123) the scheduling unit 120 that the evaluation is finished. In the step 121, the component 120 informs the broadcasting unit 130 that it can broadcast the modifications of the outputs (if there are any). The component 120 also executes its own policy, as appropriate.

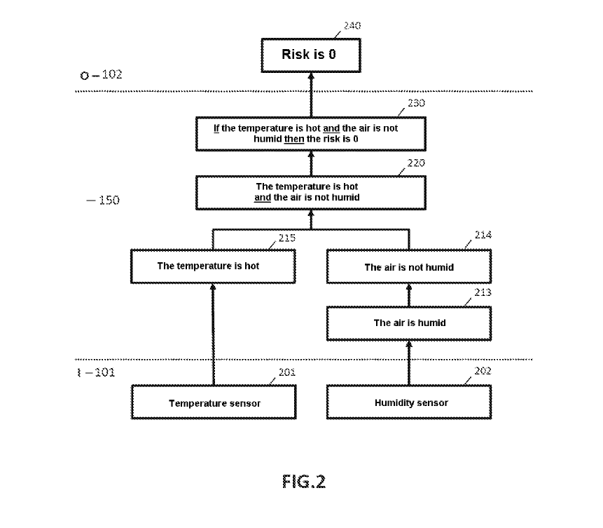

FIG. 2 represents an example of rule in graph form.

According to one aspect of the invention, the rules base of the expert system can be optimized, in particular the representation of this rules base.

Furthermore, according to another aspect of the invention, the evaluation unit can also be optimized. In particular, the evaluation 140 can be selective, that is to say proceed with the evaluation of only the expressions impacted by the observed change regarding certain inputs 101.

Advantageously, the method according to the invention aims to optimize the computations or arithmetic operations to only the necessary operations or computations. In particular, the method avoids the execution of a portion of code whose results are not (really or strictly) necessary (e.g. it is pointless to compute a result which is not used). The method according to the invention is advantageously economical in computation, improving the associated response times.

Physically, the method according to the invention for calculating an expression or rule of the expert system only when necessary, it is advantageous to represent the dependency between all the elements which make up the rule or the expression. In this way, optimizations can be conducted (eliminations of the redundancies, computations restricted to only the necessary computations, etc.).

A rule—within the meaning of the invention—consists of several elements: propositions, expressions (unary, binary, etc.) and conclusions. The propositions can comprise inputs (for example linguistic variables in the context of fuzzy logic).

For example, in FIG. 2, in the rule or expression 230 “if the temperature is hot and the air is not humid then the risk is zero”, the expression 215 “the temperature is hot” is a first proposition, the expression 213 “the air is humid” is a second proposition. The expression 214 “the air is not humid” is a unary expression, the expression 220 “the temperature is hot and the air is not humid” is a binary expression and the expression “the risk is zero” is a conclusion. To be able to evaluate the conclusion, it is necessary to evaluate the expression “the temperature is hot and the air is not humid”, which depends on the expression 215 “the temperature is hot” and on the expression 214 “the air is not humid”, which depends on the expression 213 “the air is humid”, which depend on the temperature and on the measurement of the humidity of the air. In order to represent these dependencies effectively, it is advantageous to check that each expression exists only once in the representation chosen.

In an advantageous embodiment, the rules base can be represented using a graph in which each node represents an entity (e.g. variable, expression, conclusion, rule, etc.). An arc between two nodes A and B, denoted A→B, indicates that the evaluation of B depends on the evaluation of A. In other words, when A changes value, the value of B must be recomputed. Thus, when a certain subset of the inputs changes at a time t, only the nodes affected are re-evaluated.

In most of the existing systems, a rule is represented by a tree and therefore a rules base corresponds to a forest of trees. In the context of the invention, a tree structure is insufficient because it is possible for rules to share entities (for example a same proposition). The graph representation advantageously makes it possible to obtain the uniqueness of the representation of each expression or entity. This uniqueness avoids the redundancy of the computations. By means of a graph representation, it is sufficient to check in all the nodes of the graph that none of them bears the same information.

This representation of the rules base in graph form combined with rules expressed in plain language is particularly advantageous for the manipulation of a fuzzy expert system. In effect, for a same physical variable, based on the function of belonging, the same fuzzy value can be associated to different values after “fuzzification”, i.e. application of the fuzzy logic techniques. For example, for if the variable considered is the temperature, if the belonging function is a trapezium whose small base is located between the values 15° and 25° and at 1 on the ordinates, then all the temperature values between 15° and 25° have the value 1 after fuzzification. In that case, there will be no computation beyond the fuzzification of the temperature. This aspect makes the implementation of the method practical the sensors supply values which oscillate slightly or in a limited manner. According to this implementation, if the value of a node does not change, its neighboring nodes are not re-evaluated, saving on computations.

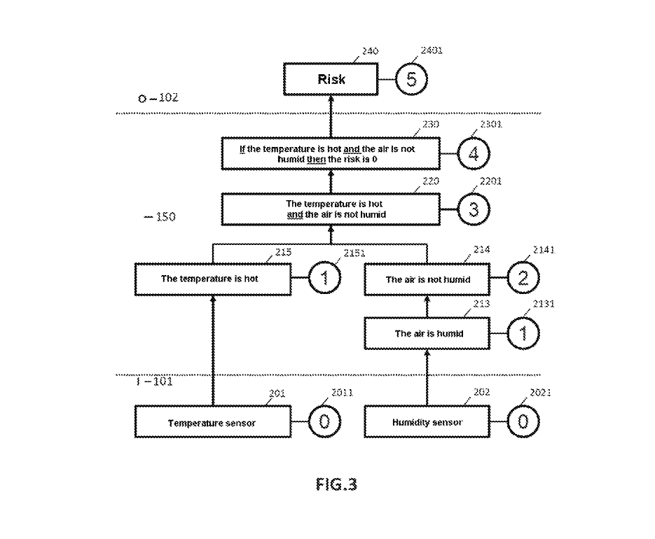

FIG. 3 illustrates an example of graph with nodes exhibiting priorities.

In some embodiments, the representation of the rules base by a graph may not be sufficient. As FIG. 2 shows, if the temperature and the humidity change at the same time t, the parent nodes will be evaluated until the evaluation of the expression 220 “the temperature is hot and the air is not humid” has been achieved. However, the path between the input 202 “humidity” and this expression 220 is longer than the one starting from the input 201 “temperature”. The expression 220 “the temperature is hot and the air is not humid” will be evaluated twice: a first time as dependent of the expression 215 “the temperature is hot” and the second time as dependent of the expression 213 “the air is not humid”.

To avoid this type of drawback, it is advantageous to use an oriented graph, i.e. to give an order to the nodes. Different embodiments are possible. According to a first embodiment, a queue with priority is created which processes first the nodes whose priority is the lowest and which does not accept a same object to be present twice in the queue. To give a priority to the nodes, it is possible to give the inputs a 0 priority, i.e. equal to zero, (these inputs must be evaluated first in all cases), then give a node of another type the maximum of the priorities of its antecedence incremented by one.

With a queue with priority according to a development of the invention, the expression 201 “temperature sensor” and the expression 202 “humidity sensor” are placed in the queue. In the example provided, the two expressions being of equal priority, the expression 201 “temperature sensor” will for example be evaluated and the expression 215 “the temperature is hot” will be added to the queue. Next, the expression 202 “humidity sensor” will be evaluated and the expression 213 “the air is humid” will be added to the queue. The expression 215 “the temperature is hot” is then evaluated and the expression “the temperature is hot and the air is not humid” is placed in the queue with priority. However, since the expression 213 “the air is humid” takes priority (its weight or priority coefficient 2131 is equal to 1 whereas the other expression 220 is associated with a priority 2201 equal to 3 ), it is evaluated and the expression 214 “the air is not humid” is added to the queue. Since the priority 2141 of the expression 214 is equal to 2, this expression 214 will be evaluated first and the expression 220 “the temperature is hot and the air is not humid” should be added. However, this expression 220 “the temperature is hot and the air is not humid” is already present in the queue with priority so it is therefore not added. Then, the expression 220 is in turn evaluated. This way, a double evaluation of the expression 220 “the temperature is hot and the air is not humid” is avoided.

Regarding the computation scheduling component 120, the unit 110 (for queuing notifications of the changes of value of the inputs) watches, for each of the inputs of the system, out for changes of value. If necessary, the changes are placed in a queue in a certain order (e.g. according to the policy of this unit). At a time t, the unit 110 for queuing notifications of the changes of inputs communicates or notifies, in the step 112, the values of the new inputs to the scheduling unit 120.

Among other examples, a policy can express the need to merge changes of values which have occurred consecutively. A policy may also consider that modifications of two different inputs occurring at intervals of a few milliseconds are in fact concomitant (”substantially” concomitant). In other words, a policy can configure or predefine assimilations or mergings or aggregations of data. The latter policy can be used when it is known that the values of the inputs are provided by a communication means with a certain latency (network, etc.).

The scheduling unit 120 which receives a communication or a notification from the unit 110 reacts according to its own policy. A simple policy may consist in immediately triggering the evaluation of the neighboring nodes of each of the nodes representing the inputs which have been changed. It is also possible to implement having one or more sophisticated policies which can consist, for example, in managing the parallel computation or the distribution of the computations.

In certain cases, the computations can in effect be allocated to several cores and/or several multicore machines. More specifically, either the different times are processed on different cores or machines, or, for a given time t, the entities to be evaluated are separated (if that is possible) in order to be evaluated independently. According to one embodiment of the invention (combining a representation in graph form of the rules base), this separation can be implemented as follows: in the graph G which represents the rules base, a graph G′ included in G is selected, such that there is a path starting from the inputs which have just been modified. Then, there is a search in G′, if they exist, for the connected graphs Gi for which there is no common edge between these different Gi. This particular case occurs for example in the presence of two rules which share no common expression or entity. Each connected graph Gi can then be evaluated in parallel (i.e. be the subject of parallelized computations). Optionally, for additional optimization purposes, other policies can be implemented to take account, for example, of the capacities and of the occupancy rate of the machines used. Once a graph Gi has finished being processed by the evaluation unit 140, the result is supplied to the result broadcasting unit 130. This unit 130, according to its policy, can indicate the new values of the modified outputs. The unit 130 can also broadcast or communicate more information, if necessary (for example, information for the interpretation or the understanding of the results).

In one development, time management rules are added and combined with the rules of the rules base. Notably disclosed is a system for which one or more expiration values are associated with the expressions or rules which are manipulated. In an expert system intended to continuously process data, it is for example advantageous to express an expression in the form: “if an event has occurred in the last 10 minutes then . . . ”. Assuming that such an event has occurred at t0, at t0+5 minutes, the proposition is true. On the other hand, it will no longer be true at t0+15 minutes because the time window of 10 minutes will have expired. An expression like “an event has occurred in the last 10 minutes” can therefore evolve, i.e. change expression or value, and do so without an input changing value. According to one embodiment of this expiration technique, certain expressions (e.g. time expressions or expressions containing time references) can be “expirable”, that is to say that their value has a limited duration and/or that these expressions know that they must be recomputed at the end of a certain time (which can be parameterized or parameterizable, e.g. dependent on variables or else configured/configurable). On expiration of their value, these expressions are communicated by the scheduling unit 120 to the evaluation unit 140. Based on the queue of the inputs and its policy, the scheduling unit 120 decides in particular the moment at which the expression must be re-evaluated.

The present invention can be implemented from hardware and/or software elements. It can be available as computer program product on a computer-readable medium. The medium can be electronic, magnetic, optical or electromagnetic.

The device can use one or more dedicated electronic circuits or a general-purpose circuit. The technique of the invention can be produced on a reprogrammable computation machine (a processor or a microcontroller for example) executing a program comprising a sequence of instructions, or on a dedicated computation machine (for example, a set of logic gates like an FPGA or an ASIC, or any other hardware module).

According to one embodiment, the device comprises a computer-readable storage medium (RAM, ROM, EEPROM, flash memory or another memory technology, CD-ROM, DVD or another optical disk medium, magnetic cassette, magnetic tape, magnetic storage disk or another storage device, or another computer-readable non-transient storage medium) coded with a computer program (that is to say several executable instructions) which, when it is run on a processor or several processors, performs the functions of the embodiments described previously.

As an example of hardware architecture suitable for implementing the invention, a device can comprise a communication bus to which are linked a central processing unit or microprocessor (CPU), which processor can be “multi-core” or “many-core”; a read only memory (ROM) being able to comprise the programs necessary for the implementation of the invention; a random access memory or cache memory (RAM) comprising registers suitable for recording variables and parameters created and modified during the execution of the above-mentioned programs; and a communication or I/O (input/output) interface suitable for transmitting and receiving data.

In the case where the invention is installed on a reprogrammable computation machine, the corresponding program (that is to say the sequence of instructions) can be stored in or on a removable storage medium (for example an SD card, a DVD or Blu-ray disk, a mass storage means such as a hard disk, e.g. an SSD) or non-removable, volatile or non-volatile storage medium, this storage medium being partially or totally readable by a computer or a processor. The computer-readable medium can be transportable or communicable or mobile or transmissible (i.e. via a 2G, 3G, 4G, Wifi, BLE, optical fiber or other such telecommunication network).

The reference to a computer program which, when executed, performs any one of the functions described previously, is not limited to an application program running on a single host computer. On the contrary, the terms computer program and software are used here in a general sense to refer to any type of computer code (for example, application software, firmware, microcode, or any other form of computer instruction) which can be used to program one or more processors to implement aspects of the techniques described here. The computing means or resources can notably be distributed (“Cloud computing”), possibly with or according to peer-to-peer technologies. The software code can be executed on any appropriate processor (for example a microprocessor) or processor core or a set of processors, whether they are provided in a single computation device or distributed between several computation devices (for example as possibly accessible in the environment of the device). The executable code of each program allowing the programmable device to implement the processes according to the invention can be stored, for example, in the hard disk or in read-only memory. Generally, the program or programs will be able to be loaded on one of the storage means of the device before being executed. The central processing unit can control and direct the execution of the instructions or portions of software code of the program or programs according to the invention, instructions which are stored in the hard disk or in the read-only memory or else in the other abovementioned storage elements.

In a nonlimiting manner, the detectors (or sensors) can comprise one or more of the detectors or sensors chosen from among the sensors of pressure, flow, temperature, oxygen, speed, motion, position, location, radioactivity, energy, chemical products or components (e.g. nitrogen monoxide, ozone, smoke, pollutants, etc.) or of biological products or components (e.g. viruses, contaminants, pollens, etc.). The sensors can comprise one or more MEMS, magnetometers, hygrometers, gyroscopes, accelerometers, biosensors, radars, sonars, cameras, 3D scanners etc. The actuators can be of pneumatic, hydraulic, electrical, mechanical, magnetic, Peltier effect, piezoelectric or electroluminescent etc. type. They can for example comprise one or more actuating cylinders, motors, heating resistors, lamps, acoustic chambers, electromagnets, or even thermo-coolers, ionizers, valves, relief valves, winders, etc.

In this case, the sensors and actuators according to the invention can be those used in the context of home automation applications. The actuators can comprise switches, keyboards, dimmers, temperature sensors, passage sensors, presence sensors, humidity sensors, brightness sensors, smoke detectors and the like. The invention will advantageously be applicable for the management of lighting, heating, air conditioning, shutter opening/closing, garden sprinkling, video surveillance, door opening/closing, ventilation, lighting, access systems or of any other system that can be controlled by a home automation system.

1. A method implemented on a management computer of a rules base, the method comprising the steps of:
receiving an input value to be evaluated;
queuing the input value in a queue;
selecting, in the queue, a queued input value;
determining an output value by evaluating, by inference by means of the rules base, the queued input value selected.

2. The method as claimed in claim 1, further comprising a step of broadcasting one or more output values.

3. The method as claimed in claim 1, the step of evaluating a selected queued input value comprising a step of scheduling in time and/or in space the evaluations of the queued input values.

4. The method as claimed in claim 1, a selection of input values having been selected being evaluated.

5. The method as claimed in claim 1, the method further comprising a step of separating the graph corresponding to the rules base into several separate sub-graphs, a step of selecting at least one sub-graph comprising a node corresponding to a selected queued input value and a step of evaluating said selected sub-graph.

6. The method as claimed in claim 5, the step of evaluating a sub-graph comprising a step of browsing said sub-graph, a step of recursively associating a priority with each node of the sub-graph and a step of evaluating the nodes by ascending priority.

7. The method as claimed in claim 1, the method further comprising a step of comparing the character strings that make up the expressions that make up the rules of the rules base, a step of deleting the redundancies between said expressions so as to obtain unique expressions and a step of evaluating said unique expressions.

8. The method as claimed in claim 1, a part of a rule of the rules base being associated with a time expiration parameter/value.

9. The method as claimed in claim 1, two substantially concomitant input values being assimilated into one and the same input value.

10. The method as claimed in claim 1, at least one rule being expressed in plain language.

11. The method as claimed in claim 1, the evaluation by inference being performed according to 0-order logic, 1^{st}-order logic or according to fuzzy logic.

12. A computer program product, said computer program comprising code instructions making it possible to perform the steps of the method as claimed in claim 1, when said program is run on a computer.

13. A system comprising means for implementing the method as claimed in claim 1.

14. The system as claimed in claim 13, comprising
means for receiving an input value to be evaluated;
means for evaluating, by inference by means of the rules base, an output value corresponding to the input value;
wherein the system comprises:
storage means for queuing the input value;
computation means for selecting a queued input value and for scheduling in time and/or in space the evaluations of one or more queued input values;
computation means for evaluating the queued selected queued input value as an output value;
input/output means for broadcasting one or more output values.

15. The system as claimed in claim 13 comprising:
an input/output component for receiving one or more input values;
a queuing component suitable for performing one or more of the steps of storing, grouping together, merging and deleting input values;
a scheduling component suitable for performing one or more of the steps of selecting, deleting, grouping together, merging, allocating queued input values;
an evaluation component suitable for evaluating one or more input values queued and manipulated by the scheduling component by inference by means of the rules base;
a broadcasting component suitable for selecting and communicating one or more input values.
